(19) United States
(12) Patent Application Publication
(10) Pub. No.: US 2007/0073004 A1
(43) Pub. Date: Mar. 29, 2007

(54) Hyperbranched (pamam) polymers via a one pot process

(75) Inventors: Donald A. Tomalia, Midland, MI (US); Douglas R. Swanson, Mt. Pleasant, MI (US)

Correspondence Address: TECHNOLOGY LAW, PLLC, 3595 N. SUNSET WAY, SANFORD, MI, 48657, US

(73) Assignee: DENDRITIC NANOTECHNOLOGIES INC., MT PLEASENT , MICHIGAN (MI)

(21) Appl. No.: 10/568,481

(22) PCT Filed: Sep. 10, 2004
(86) PCT No.: PCT/US04/29384

§ 371 Date: Nov. 9, 2006

Related U.S. Application Data
(60) Provisional application No. 60/502,800, filed on Sep. 12, 2003.

(51) Int. Cl. C08F 120/10

(52) U.S. Cl. 525/330.3; 525/374

(57) ABSTRACT

Methods of providing hyperbranched polymers by polymerization of appropriate AB₂ monomers derived from the reaction of tris-(2-aminoethyl) amine and various other materials, namely, succinic anhydride, methyl acrylate, and dimethyl ita-conate.

This application claims priority from U.S. Provisional patent application 60/502,800, filed Sep. 12, 2003.

The invention disclosed and claimed herein deals with methods of providing hyperbranched polymers by polymerization of appropriate AB₂ monomers derived from the reaction of tris-(2-aminoethyl) amine and various other materials.

The essence of this invention is to provide relatively inexpensive methods for preparing such polymers that will eliminate the laborious methods used in the industry today. A further object is to provide polymers that have high thermal stability, low polydispersity of the polymer, and in effect, provide polymers that do not undergo retro-Michael reactions by unzipping the polymer to produce by-product fragments and a loss of polydispersity.

### BACKGROUND OF THE INVENTION

One of the inventors herein reported the synthesis of dendrimers in the early 1980s by the“divergent interactive reaction method wherein the interactive reaction sequence involved (a) Michael addition of an alkyl acrylate to appropriate α, ω-alkylene amine cores, followed by (b) amidation of resulting ester terminal groups with an excess of α, ω-alkylene diamine (i.e. preferably ethylenediamine EDA). The molecules ranged in size from 10 Å to 130 Å in diameter for generation 0 (G=0) through generation G=10. PAMAM dendrimers are monodispersed spherical conformations with highly branched three-dimensional structures that provide surfaces for the attachment of a number of functional groups or molecules. In these polymers, with each new layer that is synthesized, the molecular weight of the dendrimer increases exponentially, the number of primary amine surface groups exactly doubles, and the diameter increases by about 10 Å.

As dendrimers grow in generations, the subsequent increase in exterior branching density begins to impart various structural effects to the polymer shape. Lower generation dendrimers, on the order of 0 through 4 show a flexible, flat shape, while at the higher generations of 5 through 10, the congested branching induces a persistent, spherical conformation. Beginning at generation 4 using an ethylenediamine core, the interior of the dendrimer develops inter void spaces that are accessible to molecules that may be encapsulated for various uses.

Dendritic purity, that is isomolecularity, is typically around 98% due to small defects in branch formation during synthesis. These defects may be due to retro-Michael reactions or intramolecular macrocyclic formation.

One of the attributes of the instant invention is to provide polymers that do not fall subject to the retro-Michael reactions.

### BRIEF DESCRIPTION OF THE DRAWINGS

FIG. 1 is a polyacrylamide gel electrophoresis result of polymeric products wherein G=2 to 6 ladder, one pot experiments A, B, and C, G=4, 5, and 6, 5% homogeneous gel, polyacrylamide.

FIG. 2 is a polyacrylamide gel electrophoresis result of polymeric products wherein G=2 to 6 ladder, one pot of A, B, C, G=4, 5, 6 and 5 to 20% gradient gel, polyacrylamide.

FIG. 3 shows the reaction scheme of an AB₂ monomer using TREN and methyl acrylate.

FIG. 4 shows the reaction scheme of an AB₂ monomer using TREN and succinic anhydride.

FIG. 5 shows the reaction scheme of an AB₂ monomer using TREN and dimethyl itaconate.

### THE INVENTION

PAMAM dendrimers are quite well known in the prior art and there are multiple publications with regard to their preparation and their analytical characterization.

The prior art synthesis of PAMAM dendrimers produces precise structures through generation five. In this two step procedure the amidation is the most costly step and requires large excesses of ethylene diamine (EDA). and the process has long reaction times. Also, the excess EDA is removed only after long distillation times and the resulting post residue contains trapped EDA that must be further processed by, for example for generations 0 or 1, a wiped film still, and for generations of 2 to 10, ultrafiltration. The net result after cost analysis of the process is that these operations constitute a very large labor component consisting of about 70 to 80% of the total cost that can be severely reduced or eliminated.

One other drawback of the prior art PAMAM dendrimer architecture is its inherent thermal instability. The primary amines on the surface can undergo transamidation with another dendrimer to produce a crosslink resulting in oligomers. Most any acrylate moiety in the molecule can undergo retro-Michael reaction essentially by unzipping the repeat units. This retro-Michael product can then Michael add to another amine in the same dendrimer or another dendrimer leading to a loss of polydispersity and the well-defined structures that are desired.

Any approach to producing an inexpensive dendritic material must incorporate thermal stability, low labor cost as goals, while maintaining low polydispersity. In these first efforts the unique chemical properties of tris-(aminoethyl)amine (TREN) was examined along with three different reactants, namely, methyl acrylate, succinic anhydride, and dimethyl itaconate to provide the thermal stability, among other desirable properties.

The TREN component provides a branch point whereas the co-monomers provide the thermal stability since the resulting products are not susceptible to retro-Michael reactions. The polydispersity can be preserved by the unusual amidation properties of TREN.

The reactive intermediates provided by the reaction of TREN and the three reactants set forth above can be carried out using a ratio of TREN to Reactant of 1:1, 1;2, and 1:3 for purposes of this invention.

The preparation of the AB₂ monomers is carried out at a temperature in the range of 0 to 10° C., with the preferred range being about 0 to 4°. The time for the reaction is not critical, but the reaction should be run for a minimum of about one hour. Preferred for this invention is a time ranging from about 5 minutes to about two hours, with the range of thirty minutes to one hour being especially preferred.

Using the monomers prepared as set forth above, PAMAM dendrimers can be prepared by their polymerization.

The time for the polymerization reaction should be on the order of about one hour to about three days, and it is preferred that this range be on the order of about four hours to about 24 hours. Further, the range of temperature for carrying out this reaction should be on the order of about zero ° C. to about 150° C., and it is preferred for this invention that this range be about 40° C. to about 100° C.

Solvents are typically employed in these reactions, and for this invention, it is preferred to use aliphatic alcohols, methanol being the most preferred alcohol for use herein.

The following examples illustrate the invention, but the inventors herein should not be held strictly to the examples.

### EXAMPLE 1

Preparation of AB₂ Monomers using TREN and Methyl Acrylate

For purposes of this example, the mole ratio of TREN to methyl acrylate was 1:1. The AB₂ made from this reaction at 4° C. was characterized by ¹³C NMR spectroscopy. This monomer formed at about 90 to 95% purity within 1 hour. The AB₂ monomer was prepared without solvent. Methanol was then added and the mixture heated at 40° C. in a sealed vessel for 24 hours. In this step, the AB₂ monomer is oligomerized into a cascade of high molecular weight products.

This resulting mixture was fully alkylated with the methyl acrylate for 24 hours. These fully alkylated oligomers were joined together in a high molecular weight polymer with one mole equivalent TREN per total ester added at 40° C. for 24 to 48 hours. The resulting mixture was ultrafiltered using a 1000 molecular weight cutoff membrane. Solvent was removed from the polymer to give a viscous white material in 48% yield. A polyacrylamide gel electrophoresis of the product indicates the polymer is equivalent to a G=4 PAMAM dendrimer, EDA core. Polydispersity spanned only two generations of PAMAM dendrimers in molecular weight. The amidation step was done at 4° C. for 64 hours to produce a polymer equivalent to G=4. This experiment was labeled A. In a separate experiment labeled B, the gel shows amidation at 40° C. for 24 hours giving a product equivalent to G=5 PAMAM dendrimer, EDA core. Another experiment labeled C showed no significant shift after amidation at 40° C. for 48 hours.

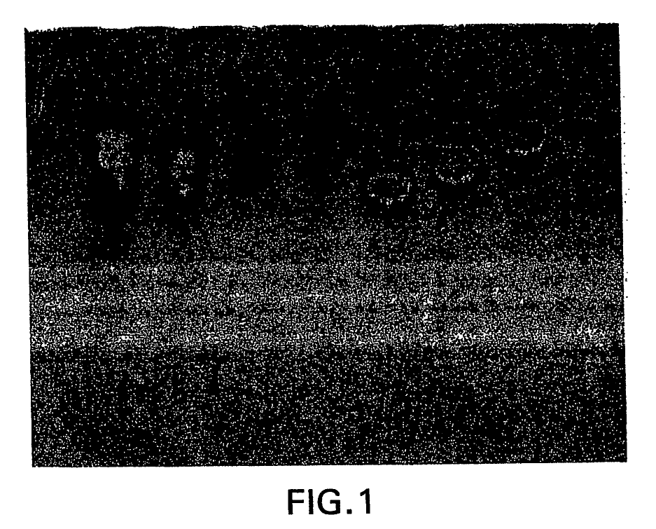

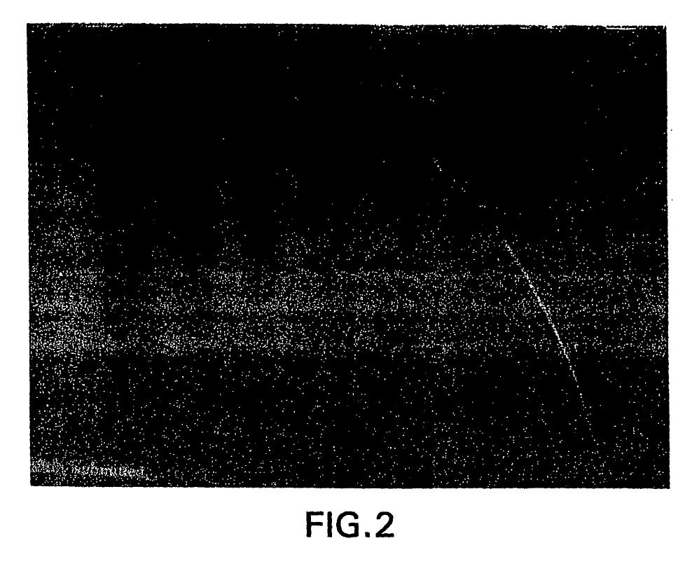

A homogeneous acrylamide gel at 5% was shown to be good for this analysis. A gradient gel does not give a clear view. The polyacrylamide gel electrophoresis of the products are shown in FIG. 1 and FIG. 2, wherein in FIG. 1, G=2 to 6 ladder, one pot experiments A, B, and C, G=4, 5, and 6, 5% homogeneous gel, polyacrylamide, while FIG. 2 shows G=2 to 6 ladder, one pot of A, B, C, G=4, 5, 6 and 5 to 20% gradient gel, polyacrylamide.

Experimental for Monomer

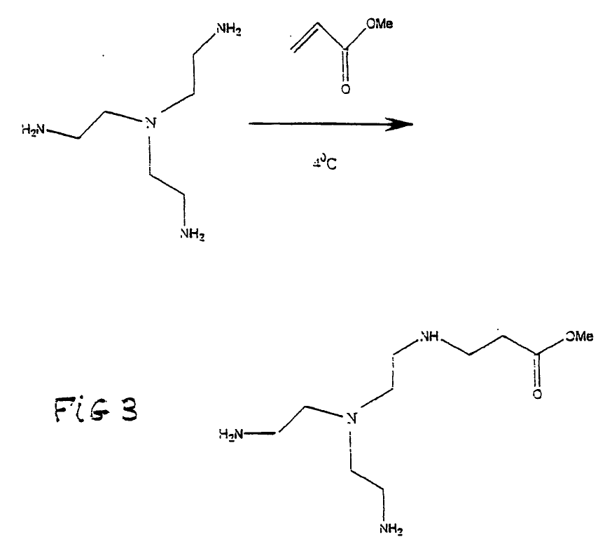

To a 10 ml round bottomed flask with a stir bar was added 2.0 gms., 13.7 mmol of TREN. While stirring and cooling to 4° C., there was added dropwise over 3 minutes, methyl acrylate, 1.0 gms., 11.6 mmol. This mixture was stirred at 4° C. for 1 hour under nitrogen. An aliquot of this resulting mixture was analyzed by ¹³C NMR spectroscopy in CDCl₃ with tetramethylsilane as an internal standard. The reaction scheme for this reaction can be found in FIG. 3.

Experimental for Polymer

The above monomer mixture was diluted with 1.0 gms. of methanol and stoppered with a rubber septum. The septum was sealed with 3 layers of Parafilm and the vessel was placed in a bath at 40° C. for 24 hours. This mixture was cooled to 25° C. and added to 12 gms., 82.02 mmol, of TREN and 12 gms. of methanol and cooled at 4° C. for about 5 minutes. This mixture was sealed as above and placed in a bath at 40° C. for 48 hours. An infrared spectrum was taken of this mixture showing a small peak for unreacted ester at 1736 cm⁻¹. Another 2 gms. of TREN was added and the mixture was heated at 40° C. for 18 to 20 hours. An IR spectrum indicated no ester remaining. The mixture was diluted with deionized water to a 5% w/w mixture and diafiltered 1200 ml, concentrated to 250 ml, and ultrafiltered with 12 re-circulations of 125 ml for a total volume of 1500 ml. The retentate was stripped of water on a Rotavap at 50° C. with 28.5 inches of Hg vacuum. This residue was dissolved in 50 ml of methanol and the volatiles evaporated on the Rotavap. This was repeated five times. The fifth aliquot of methanol was filtered through a course fritted funnel. The final residue was evacuated under high vacuum at 25° C. for 18 hours to give 9.8 gms. (48%) yield of a white sticky viscous solid.

### EXAMPLE 2

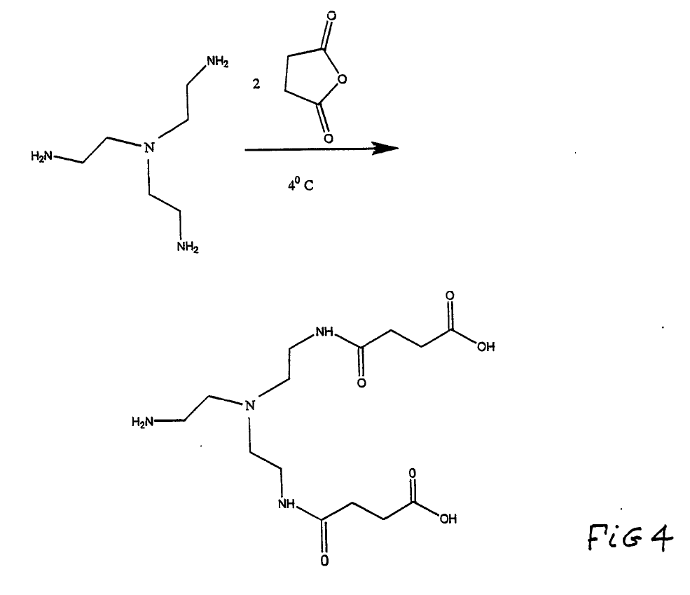

An A₂B TREN-succinic anhydride was prepared as in Example 1 using TREN (2.0 gms. 13.7 mmoles) and succinic anhydride (2.4 gms., 24 mmoles). This mixture was diluted to 25 ml with de-ionized water and stirred for 24 hours at 25° C. To this mixture was added 1-(dimethylaminopropyl)-3-ethylcarbodiimide hydrochloride (3.9)gms., 20.3 mmoles). After 24 hours at 25° C. this mixture was ultrafiltered as in example using deionized water. Workup as described in example gave 4.2 gms. (80%) yield) of a product that corresponded to G=5-6 PAMAM dendrimer by gel electrophoresis (FIG. 4).

### EXAMPLE 3

Experimental for AB₂ TREN-Dimethyl Itaconate

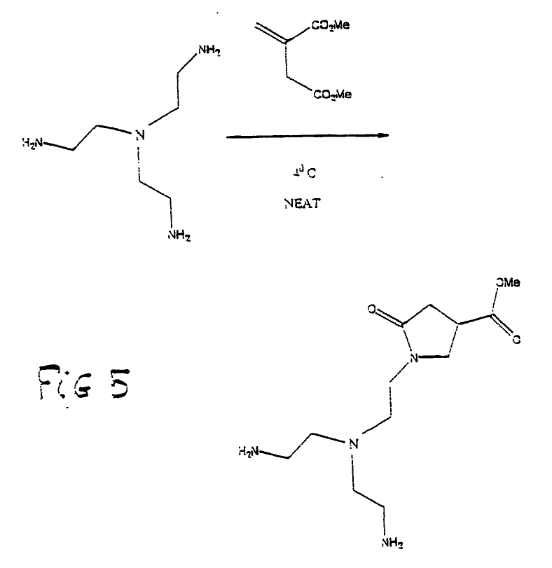

his procedure was identical to the TREN-methyl acrylate procedure using TREN (2.0 gms., 13.7 mmoles) and dimethyl itaconate (DMI) (1.84 gms., 11.6 mmoles) in the first step. In the second step, DMI (4.0 gms., 25 mmoles) was added to the reaction mixture. This resulting mixture was added to TREN (5.85 gms., 39.6 mmoles) and methanol (6 gms.) at 4° C. and heated at 40° C. for 24 hours. See FIG. 5.

What is claimed is:

1. A method of preparing a monomer selected from the group consisting essentially of AB₂ and B₂A monomers, the method comprising reacting, in an inert atmosphere, tris-(2-aminoethyl)amine with a material selected from the group consisting essentially of
(i) alkyl acrylates,
(ii) aryl acrylates,
(iii) alkyl methacrylates,
(iv) aryl methacrylates,
(v) succinic anhydride,
(vi) glutaric anhydride,
(vii) 3-propriolactone,
(viii) cyclic alkyl anhydrides,
(ix) cyclic aryl anhydrides,
(x) amine reactive cyclic anhydrides selected from the group consisting of
(a) beta-sultones, and
(b) ethylene sulfate,
(xi) dialkyl itaconates,
(xii) itaconic acids,
in a ratio of from 1:1 to 1:3, at room temperature in the range of about 0° C. to about 200° C. for a period of time in the range of about 5 minutes to about 120 minutes: thereafter, adding solvent to the reaction mass and heating the mixture at less than 200° C. for up to 24 hours.

2. A method for preparing hyperbranched, PAMAM polymers, the method comprising (I) preparing an AB₂ or B₂A monomer, comprising reacting, in an inert atmosphere, tris(2-aminoethyl)amine with a material selected from the group consisting essentially of
(i) alkyl acrylates,
(ii) aryl acrylates,
(iii) alkyl methacrylates,
(iv) aryl methacrylates,
(v) succinic anhydride,
(vi) glutaric anhydride,
(vii) 3-propriolactone,
(viii) cyclic alkyl anhydrides,
(vix) cyclic aryl anhydrides,
(x) amine reactive cyclic anhydrides selected from the group consisting of
(a) beta-sultones, and
(b) ethylene sulfate,
(xi) dialkyl itaconates,
(xii) itaconic acids,
in a ratio of from 1:1 to 1:3, at room temperature in the range of about 0° C. to about 200° C. for a period of time in the range of about 5 minutes to about 120 minutes: thereafter, adding solvent to the reaction mass and heating the mixture at less than 200° C. for up to 24 hours;
thereafter, adding one mole equivalent of tris(2-aminoethyl)amine per total ester or a slight excess in the reaction mass and heating at a temperature in the range of 4° C. to about 200° C. for a period of time ranging from about 1 hour to about 30 hours

3. A method of preparing hyperbranched, PAMAM polymers the method comprising reacting the 1,7-dihydrosulfate salt of diethylenetriamine, in an inert atmosphere, with a material selected from the group consisting essentially of
(i) alkyl acrylates,
(ii) aryl acrylates,
(iii) alkyl methacrylates,
(iv) aryl methacrylates,
(v) succinic anhydride,
(vi) glutaric anhydride,
(vii) 3-propriolactone,
(viii) cyclic alkyl anhydrides,
(vix) cyclic aryl anhydrides,
(x) amine reactive cyclic anhydrides selected from the group consisting of
(a) beta-sultones, and
(b) ethylene sulfate,
(xi) dialkyl itaconates,
(xii) itaconic acids,
in a ratio of from 1:1 to 1:3, at room temperature in the range of about 0° C. to about 200° C. for a period of time in the range of about 5 minutes to about 120 minutes: thereafter, adding solvent to the reaction mass and heating the mixture at less than 200° C. for up to 24 hours;
thereafter, adding one mole equivalent of tris(2-aminoethyl)amine per total ester or a slight excess in the reaction mass and heating at a temperature in the range of 4° C. to about 200° C. for a period of time ranging from about 1 hour to about 30 hours.

4. A monomer prepared by the process as claimed in claim 1.

5. A polymer prepared by the process as claimed in claim 2.

6. A polymer prepared by the process as claimed in claim 3.
